(19) United States
(12) Patent Application Publication
(10) Pub. No.: US 2007/0062682 A1
(43) Pub. Date: Mar. 22, 2007

(54) Multiple-hole tube for heat exchanger and manufacturing method thereof

(76) Inventors: Fumihiko Sagi, Iwaki (JP); Masami Murayama, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/521,483

(22) Filed: Sep. 15, 2006

(30) Foreign Application Priority Data
Sep. 16, 2005 (JP) 2005-270733

(51) Int. Cl. F28F 9/02; B23P 6/00

(52) U.S. Cl. 165/173; 29/890.032; 29/890.038

(57) ABSTRACT

A multiple-hole tube for heat exchanger, which can be manufactured in a simply way and at a low cost, and a manufacturing method thereof are disclosed. A pair of copper plates 20 with grooves 14 formed in a longer direction by rolling copper plate 11 with a form rolling roller are prepared. A sheet type brazing filler metal is interleaved between bond surfaces, each of which is a surface on the side of grooves 14 of copper plate 20. Copper plates 20 are heat-bonded to each other after both are aligned with respect to the grooves.

### BACKGROUND OF THE INVENTION

The present invention relates to a condenser for high pressure refrigerant such as CO₂ gas used for a heat exchanger.

A multiple-hole tube made of aluminum or copper is generally used as a condenser used for a heat exchanger. As shown in FIG. 7, a plurality of holes (flow channels) is arranged in parallel inside of multiple-hole tube body 71 in multiple-hole tube 70 made of aluminum, which is integrally molded by extrusion molding. On the other hand, it is nearly impossible to mold integrally a multiple-hole tube made of copper by extrusion molding. Accordingly, a method shown in FIG. 8A is adopted in order to form a section like one of multiple-hole tube 70 made of aluminum. In FIG. 8A, a pair of copper plates 82, in which a plurality of grooves 81 are formed in a longer direction of the copper plates, are used. Surfaces on the side of the grooves of copper plates 82 are set as bond surfaces. A sheet of brazing filler metal 83 is interleaved between those bond surfaces. A multiple-hole tube is manufactured by heat-bonding the copper plates 82 as shown in FIG. 8B after aligning the grooves of both copper plates to each other. There are some processing methods such as etching, cutting and so on as a method of forming grooves 81 in copper plate 82.

As a manufacturing method of the multiple-hole tube made of copper, there is a different method that a plurality of capillary tubes are arranged on a copper plate and they are integrally bonded with brazing filler metal. In this method, a capillary tube coil 91 shown in FIG. 9 is leveled straight by leveler 93. Then, it is cut to the product size with a cutter 94 to obtain capillary tube 95. Further, copper strip coil 96 shown in FIG. 10 is leveled flatly by leveler 98. Then, it is cut to the product size with a cutter 99 to obtain copper plate 100.

Next, a sheet of brazing filler metal is provided on copper plate 100, and a plurality of capillary tubes 95 are arranged thereon in parallel as shown in FIG. 11A. In this state, capillary tubes 95 are positioned so that the pitch between them may become equal as shown in FIG. 11B.

Copper plate 100, brazing filler metal 101 and capillary tubes 95 are clamped in this state and heated in a burner furnace to braze them as shown in FIG. 11C. As a result, a multiple-hole tube 110 for heat exchange in which a plurality of capillary tubes (flow channels) 95 are arranged in parallel on copper plate 100 is completed as shown in FIG. 11D.

Japanese Patent Application Laid-Open No. 2003-172588, Japanese Patent Application Laid-Open No. 2002-168578 and Japanese Patent Application Laid-Open No. 2000-74587 disclose the prior art described above.

In general, grooves 81 are formed by using an etching process after cutting copper plate 82 to shorters (product size). However, in the etching process (resist, exposure, developing, etching or removal of the resist), it takes a long time to process according to the depth of a groove, and it is complicated to dispose of waste solution of etchant. And even if volume efficiency is tried by cutting the copper plate to longers, it is complicated to perform an etching process or to handle them in an etching process chamber.

On the other hand, when grooves 81 are formed by using a cutting process, it becomes necessary to deal cutting chips or to deburr though grooves 81 is formed easily by means of a metal saw, etc.

In addition, because groove 81 is chipped away from copper plate 82 in each method, the material is wasted and thus the material becomes expensive.

On the other hand, because each part is combined to bond in the one with capillary tube 95, the assembly becomes complex. Moreover, because the heat transfer distance (total of the wall thickness of capillary tube 95, brazing filler metal 101 and copper plates 100) increases according to the combination relation among capillary tube 95, brazing filler metal 101, and copper plate 100, the heat resistance grows and the performance of the multiple-hole tube for heat exchanger is deteriorated consequently.

### SUMMARY OF THE INVENTION

An object of the present invention is to provide a multiple-hole tube for heat exchanger, which can be manufactured in a simply way and at a low cost, and a manufacturing method thereof.

In order to attain the above-mentioned object, a multiple-hole tube for heat exchanger according to a first aspect of the present invention comprises: a pair of copper plates with grooves formed in a longer direction by rolling copper plate with a form rolling roller, a sheet type brazing filler metal interleaved between bond surfaces, each of which is a surface on the groove side of said copper plate, wherein said copper plates are heat-bonded to each other after both are aligned with respect to the grooves.

Preferably, the multiple-hole tube for heat exchanger further comprises minute raised portions provided on surfaces of said grooves.

Preferably, in the multiple-hole tube for heat exchanger the surface on the groove side of the copper plate is flattened by means of a plain roller.

A method of manufacturing a multiple-hole tube for heat exchanger according to one aspect of the present invention comprises the steps of: providing a pair of copper plates with grooves formed in a longer direction by rolling copper plate with a form rolling roller, providing a sheet type brazing filler metal between bond surfaces, each of which is a surface on the groove side of said copper plate, and heat-bonding said copper plates to each other after aligning them with respect to the grooves.

Preferably, a method of manufacturing a multiple-hole tube for heat exchanger further comprises a step of providing minute raised portions on surfaces of said grooves when forming said grooves by the roller.

Preferably, a method of manufacturing a multiple-hole tube for heat exchanger further comprises a step of flattening said surface on the groove side of the copper plate by rolling with a plain roller after making sectional form of said groove semicircular.

The present invention can obtain a multiple-hole tube for heat exchanger where the manufacturing process is easy, and the material is not wasted.

### BRIEF DESCRIPTION OF DRAWINGS

FIG. 1 is an explanatory drawing of a manufacturing process of a copper plate with grooves.

FIG. 2A to FIG. 2C each shows a section of the copper plate shown in FIG. 1, and FIG. 2A is a sectional view taken along line 2A-2A, FIG. 2B is a sectional view taken along line 2B-2B, and FIG. 2C is a sectional view taken along line 2C-2C.

FIG. 3A to FIG. 3F show a manufacturing process of a multiple-hole tube for heat exchange, FIG. 3C is a sectional view taken along line 3C-3C of FIG. 3B and FIG. 3F is a sectional view taken along line 3F-3F of FIG. 3E.

FIG. 4 shows a manufacturing process of a condenser in which a multiple-hole tube for heat exchange is used.

FIG. 5 is an explanatory drawing of assembly of header pipes and a multiple-hole tube for heat exchange bended like U character.

FIG. 6 is an enlarged perspective view of section of the multiple-hole tube for heat exchange shown in FIG. 5.

FIG. 7 is a perspective view of section of a conventional multiple-hole tube for heat exchange made of aluminum.

FIG. 8A and FIG. 8B are explanatory drawings of a manufacturing process of a conventional multiple-hole tube for heat exchange made of copper.

FIG. 9 is an explanatory drawing of a manufacturing process of a capillary tube.

FIG. 10 is an explanatory drawing of a manufacturing process of a copper plate.

FIG. 11A to FIG. 11D are explanatory drawings of a manufacturing process of a capillary tube type multiple-hole tube for heat exchange, in which capillary tubes and a copper plate are used.

FIG. 12A to FIG. 12D are explanatory drawings of a manufacturing process of a condenser, in which a capillary tube type multiple-hole tube for heat exchange is used.

### DETAILED DESCRIPTION OF THE PREFERRED EMBODIMENTS

Hereafter, embodiments of the present invention will be explained by referring to attached drawings.

First of all, it is nearly impossible to form a multiple-hole tube by extruding the copper material by using the technique of the aluminum extrusion, because it is impossible to provide a plurality of holes 1 mm in diameter in the section of the copper extrusion material. Accordingly, a multiple-hole tube for heat exchange is manufactured by mutually bonding and integrating a pair of copper plates, on each of which a plurality of grooves are formed, by using brazing filler metal, etc. to make the same section as a multiple-hole tube of the aluminum extrusion material by using the copper extrusion material in the present invention. That is, the above-mentioned copper plate is the same as half multiple-hole tube divided into two along the line of symmetry center.

There is a feature in making the grooves of the copper plate with a form rolling roller in this embodiment. A multiple-hole tube for heat exchange according to this embodiment is manufactured as follows. Grooves are provided on one of surfaces of copper strips with a form rolling roller. A surface on the side of grooves of a copper plate is set as a bond surface. A sheet type, a powder type or a line type of brazing filler metal is interleaved between bond surfaces. The copper plates are heat-bonded to each other after they are aligned with respect to the grooves.

A multiple-hole tube for heat exchange according to this embodiment is manufactured by the following manufacturing processes.

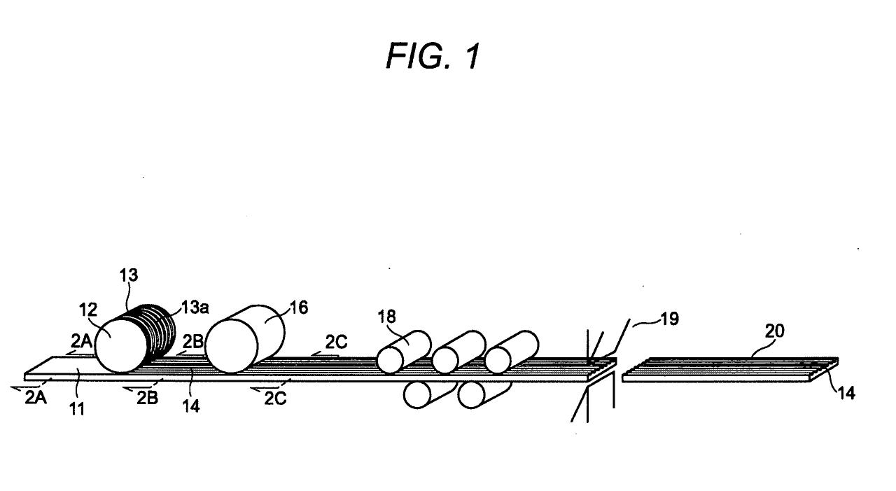

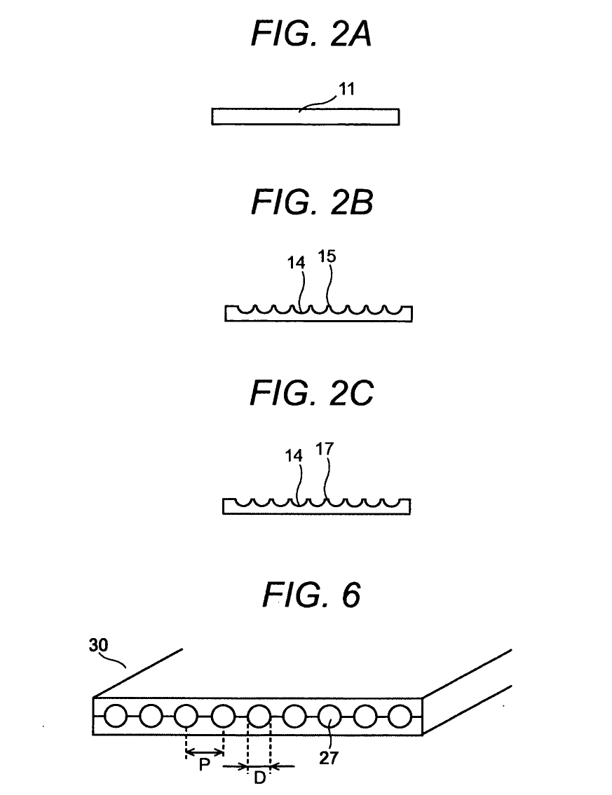

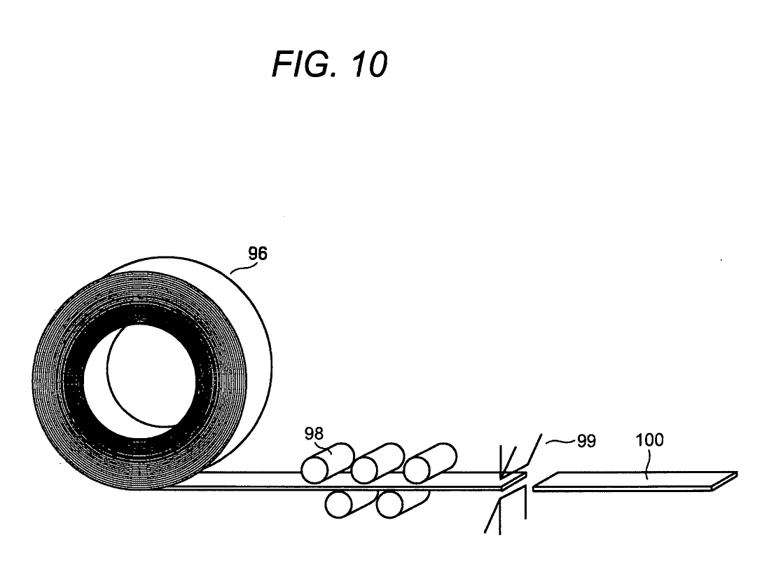

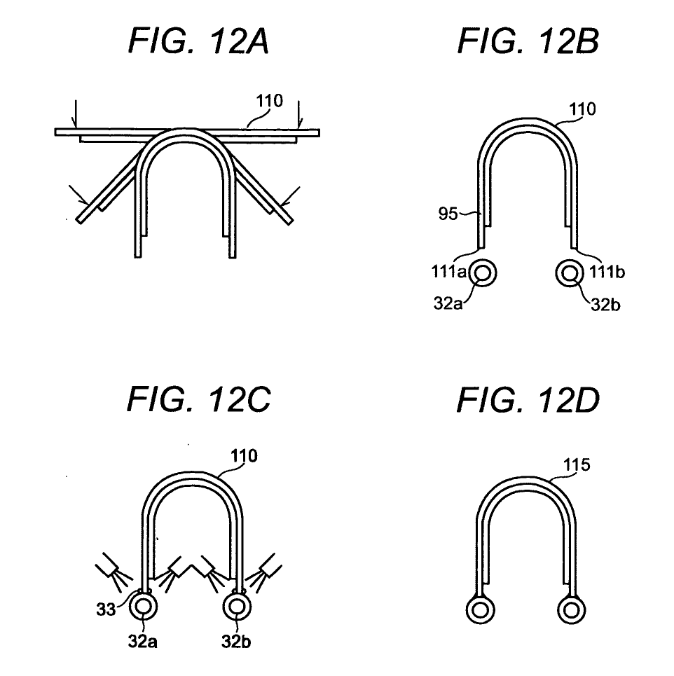

As shown in FIG. 1, copper plate 11 supplied from the copper strip coil (see FIG. 10) is continuously supplied between form rolling roller 12 and receiving roller (not shown). On one surface of copper plate 11 placed between form rolling roller 12 and receiving roller, which are rotating, grooves are provided with form rolling roller 12. Each of these grooves is nearly semicircular and has 0.5 mm in radius, for instance. Grooves 14 are continuously formed to one side of copper plate 11. On surrounding side 13 of form rolling roller 12, plural rows of convex parts (peak) 13a have been provided at equal intervals, which extend in a circumferential direction and whose section is a semicircle. Grooves 14 are formed as shown in FIG. 2B by convex parts 13a digging into copper plate 11 (see FIG. 2A) rectangular in section. The number and the radius of grooves 14 can be freely adjusted by changing the number and the radius of convex parts 13a.

The material excluded to both sides of convex part 13a when grooves 14 are formed by convex parts 13a of form rolling roller 12 digging into copper plate 11 rises on both sides of grooves 14, and raised portions 15 are formed. These raised portions 15 cause a decrease in accuracy of the size of grooves 14. Therefore, copper plate 11 on which grooves 14 are formed is rolled out by two plain rollers 16 (only one is shown in the figure) arranged at the top and bottom, raised portions 15 are flattened to form plane part 17 shown in FIG. 2C. As a result, grooves 14 of the high dimensional accuracy are obtained because they are formed like a semicircle with the shape of cross-section of grooves 14 substantially kept. Raised portions 15 mentioned above indicates the surface (non-groove formation part) between grooves 14 in the surface on the side of grooves of copper plate 11.

Copper plate 11 on which semicircular grooves 14 is formed is supplied to leveler 18 composed of correction rolls opposed like zigzag, and warp, etc. is corrected to obtain a flat plate. Afterwards, copper plate 11 corrected like a flat plate is cut into the product size with cutter 19 to complete different shape copper strip 20 (copper plate) with grooves 14.

Here, to increase the surface area of grooves 14, and to improve the heat exchange efficiency when grooves 14 are formed with rolling, it is possible to add minute raised portions (fins) to the surface of grooves 14. The minute raised portions are formed by adjusting the shape of cross-section in convex part 13a of form rolling roller 12.

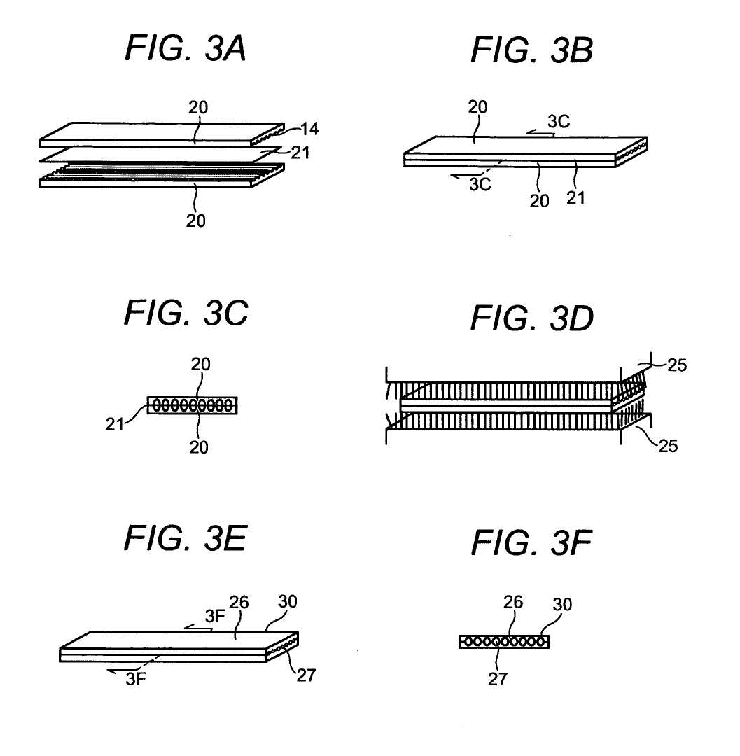

Next, the surfaces on the side of grooves 14 of both copper plates 20 are laid on each other and a sheet of brazing filler metal 21 is interleaved between the surfaces as shown in FIG. 3A. Both copper plates 20 are positioned with tool (not shown), etc. so that semicircular grooves 14 of both copper plates 20 can be aligned with each other as shown in FIG. 3B and FIG. 3C. It is heat-bonded with brazing filler metal 21 in burner reactor 25 (or, electrically heated reactor) as shown in FIG. 3D with both copper plates 20 and brazing filler metal 21 clamped under such a condition. As a result, multiple-hole tube 30 for heat exchange in which a plurality of holes 27 (channels) are arranged in parallel inside of multiple-hole tube body 26 is completed, as shown in FIG. 3E and FIG. 3F. After the completion of the brazing, a multiple-hole tube 30 for heat exchange is cooled so that the inside and outside should not be oxidized.

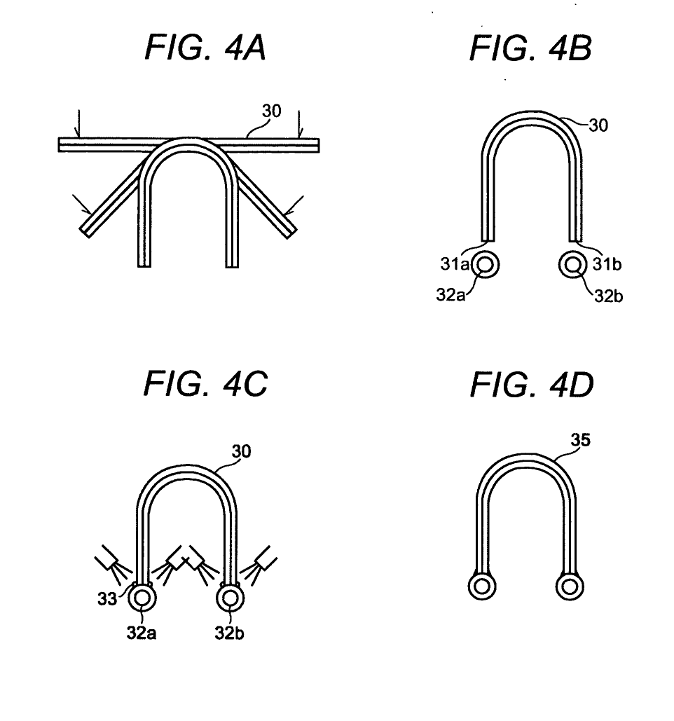

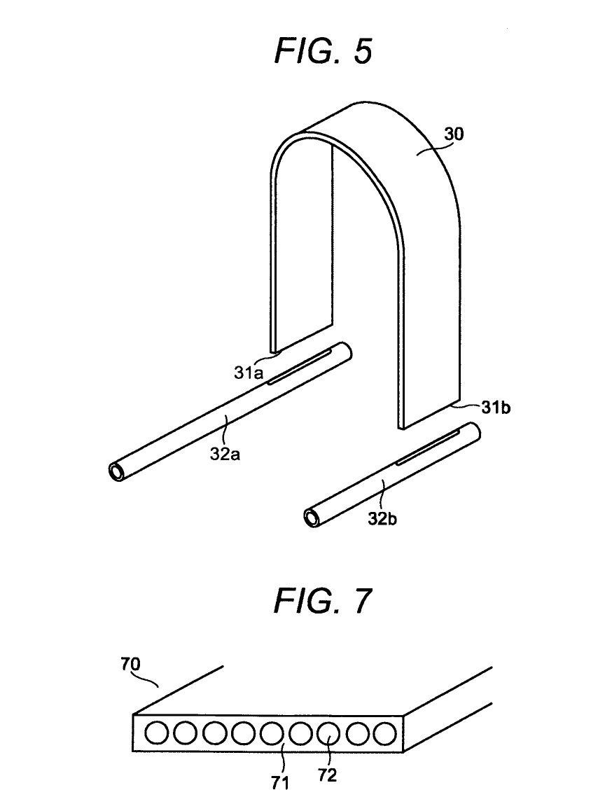

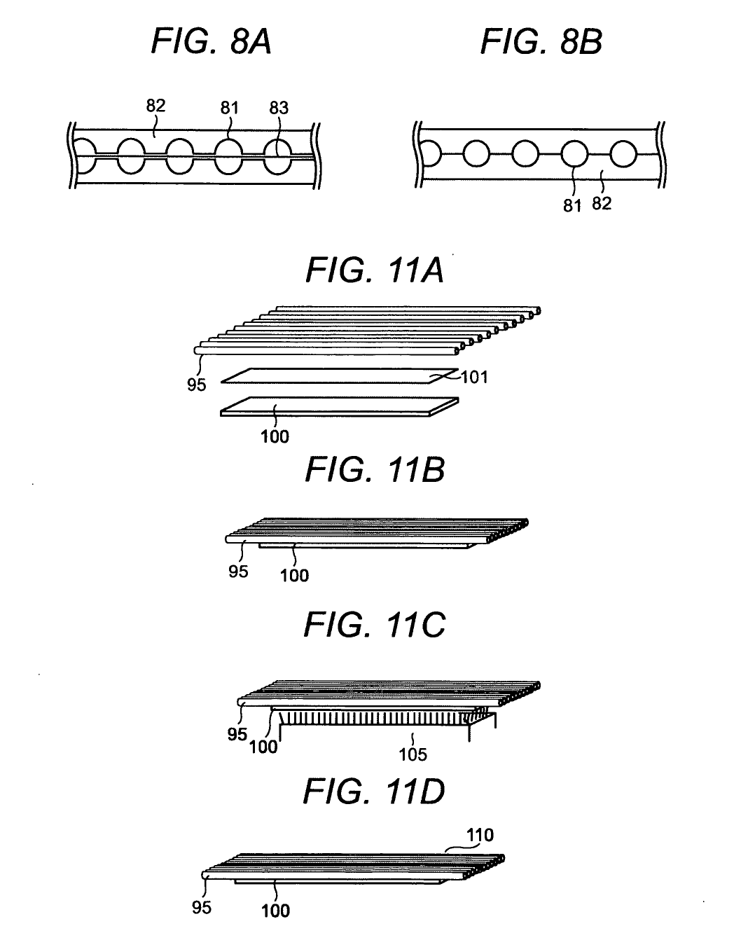

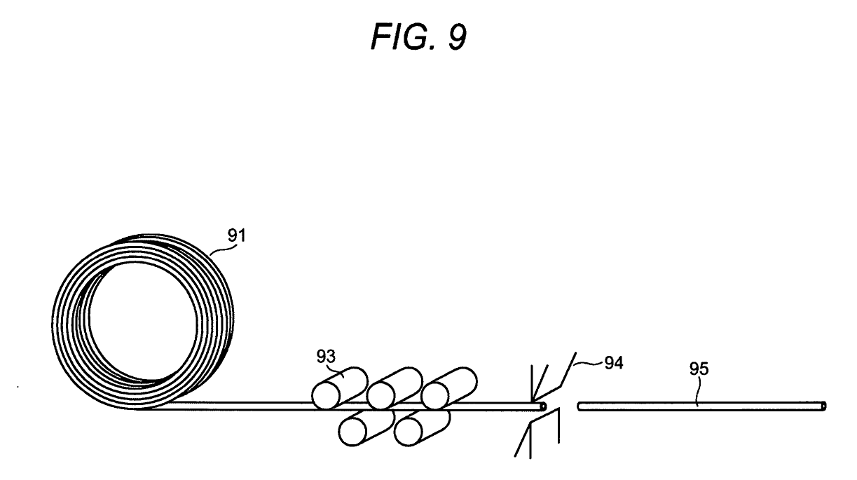

In the case that multiple-hole tube 30 for heat exchange is used as a condenser, the multiple-hole tube 30 is preformed to install header pipes in the both ends and then it is bent like U-character as shown in FIG. 4A. Afterwards, both ends 31a and 31b of multiple-hole tube 30 for heat exchange bent like U-character are inserted to header pipes 32a and 32b, respectively, as shown in FIG. 4B and FIG. 5. As a result, condenser 35 is completed as shown in FIG. 4C.

In the manufacturing process mentioned above, after copper plates 11 leveled flatly are cut in the length of the product, they are brazed. However, it is optionally possible to cut copper plates 11 after a sheet of brazing filler metal 21 is interleaved between the surfaces on the side of grooves of longer copper plates 11 with the grooves and the cooling process is completed.

The cooling method after brazing also includes a method of cooling it in the reducing gas (mixed gas of H₂+N₂). Here, it is possible to perform the brazing and the cooling processes in the vacuum though these processes are carried out in an atmosphere. In addition, the bonding of copper plates 20 does not necessarily limit to the one by brazing, and be also possible to bond by using diffused junction.

Because in the manufacturing method of a multiple-hole tube for heat exchange 30 according to this embodiment, grooves 14 of copper plate 20 with the grooves is formed by rolling, the number of processes to form grooves 14 becomes greatly few compared with the case where forms the grooves by etching or cutting in the customary way, and thus this manufacturing method is suitable for mass production. Moreover, after forming the grooves, the post-processing such as disposal of cutting chip and deburring becomes also unnecessary.

Because grooves 14 are formed by rolling, there is no waste of the material (copper plate) at all, and the material cost can be decreased.

Although raised portions 15 is formed between grooves 14 in copper plate 11 by forming grooves 14 with rolling, the raised portions can be flattened by rolling out copper plate 11 by means of plain roller 16. As a result, the dimensional accuracy of grooves 14 is improved, and when the surfaces on the side of grooves 14 of both copper plates 20 is aligned, it is possible to aligned accurately with no space.

Next, an embodiment of the present invention is explained compared with a prior art.

### EMBODIMENT

An example of a manufacturing process is explained hereinafter, where a condenser is manufactured by using a multiple-hole tube (a multiple-hole tube for heat exchange according to this embodiment) which grooves is formed in the copper plate.

1) Semicircular grooves are formed on the surface of a thin copper plate by rolling it by a form rolling roller.

2) Raised portions on both sides of the grooves are rolled out by a plain roller after the grooves are formed by the form rolling roller to make the raised portion flat. As a result, cross-section of each of the grooves becomes a completely semicircular shape.

3) The copper plate in which semicircular grooves are formed is corrected by a leveler to make it completely flat.

4) The copper plate corrected like a flat plate is cut into the product size with a cutter, and thus a different type copper strip (copper plate) which has grooves is completed.

5) The surfaces of the side of the grooves of both copper plates are aligned, and a sheet of brazing filler metal is placed between the surfaces.

6) Both copper plates are positioned with a fixing tool, etc. so that the positions of semicircular grooves of both copper plates may be aligned to each other.

7) A multiple-hole tube for heat exchange that a plurality of holes (channels) are arranged in the main body of a multiple-hole tube in parallel is completed by heating and brazing them in a burner reactor with both copper plates and the brazing filler metal clamped under such a condition.

8) After brazing, a multiple-hole tube for heat exchange is cooled so that the inside and outside of the multiple-hole tube for heat exchange should not be oxidized.

9) In the case that a multiple-hole tube for heat exchange is used as a condenser, a multiple-hole tube for heat exchange is preformed and bent like U-character to install header pipes on both ends thereof.

10) Then, both ends of the multiple-hole tube for heat exchange bent like U-character are inserted into the header pipes to assembly them.

11) Afterwards, the multiple-hole tube for heat exchange and the header pipes are brazed by using brazing filler metal to make a condenser complete.

12) High-pressure refrigerant of CO₂ gas etc. pressurized to 42 MPa or more is supplied from one of the header pipes to do the pressure test, and non-leakage of the high-pressure refrigerant is confirmed.

### PRIOR ART

One example of the conventional manufacturing process is explained hereinafter, where a condenser is manufactured by using a multiple-hole tube (the conventional capillary tube type multiple-hole tube for heat exchange) which a copper plate and capillary tubes are combined.

21) First of all, after the capillary tube coil is corrected straight by a leveler, a capillary tube is obtained by cutting it into the product size.

22) After copper strip coil 96 is corrected flatly with a leveler, a copper plate is obtained by cutting it into the product size.

23) A sheet of brazing filler metal is put on the copper plate and a plurality of capillary tubes are arranged in parallel on the brazing filler metal.

24) The capillary tubes are positioned so that the pitch between the capillary tubes may become equal in this state.

25) Copper plate 100, brazing filler metal 101 and capillary tubes 95 are clamped in this state and heated in a burner furnace to braze them. As a result, a multiple-hole tube for heat exchange in which a plurality of capillary tubes (flow channels) are arranged in parallel on copper plate is completed.

26) After brazing, a multiple-hole tube for heat exchange is cooled so that the inside and outside of the multiple-hole tube for heat exchange should not be oxidized.

27) In the case that a multiple-hole tube for heat exchange is used as a condenser, a multiple-hole tube for heat exchange is preformed and bent like U-character to install header pipes on both ends thereof.

28) Then, both ends of the capillary tubes of the multiple-hole tube for heat exchange bent like U-character are inserted into the header pipes to assembly them.

29) Afterwards, the multiple-hole tube for heat exchange and the header pipes are brazed by using brazing filler metal to make a condenser complete.

30) High-pressure refrigerant of CO₂ gas etc. pressurized to 42 MPa or more is supplied from one of the header pipes to do the pressure test, and non-leakage of the high-pressure refrigerant is confirmed.

There was no leakage though high-pressure refrigerant of the CO₂ gas etc. was used for both of the condenser which uses a multiple-hole tube for heat exchange according to this embodiment and the conventional one. For instance, in the condenser which uses a multiple-hole tube for heat exchange according to the embodiment in which inside diameter D of each hole 27 is set to φ1 mm and the hole pitch P is set to 1.7 mm as shown in FIG. 6, the leakage of the high-pressure refrigerant and the breakage of a multiple-hole tube, etc. were not found even if the condenser is pressurized with 70 MPa at the pressure test. Namely, the number of parts of the multiple-hole tube for heat exchange according to this embodiment is only two, and this structure is very suitable for mass production.

On the other hand, because the number of parts is 20 or more in the conventional multiple-hole tube for heat exchange of a capillary tube type, it is not suitable in structure for mass production goods.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A multiple-hole tube for heat exchanger comprising:
a pair of copper plates with grooves formed in a longer direction by rolling copper plate with a form rolling roller,
a sheet type brazing filler metal interleaved between bond surfaces, each of which is a surface on the groove side of said copper plate,
wherein said copper plates are heat-bonded to each other after both are aligned with respect to the grooves.

2. A multiple-hole tube for heat exchanger according to claim 1, further comprising minute raised portions provided on surfaces of said grooves.

3. A multiple-hole tube for heat exchanger according to claim 1, wherein said surface on the groove side of said copper plate is flattened by means of a plain roller.

4. A method of manufacturing a multiple-hole tube for heat exchanger comprising the steps of:
providing a pair of copper plates with grooves formed in a longer direction by rolling copper plate with a form rolling roller,
providing a sheet type brazing filler metal between bond surfaces, each of which is a surface on the groove side of said copper plate, and
heat-bonding said copper plates to each other after aligning them with respect to the grooves.

5. A method of manufacturing a multiple-hole tube for heat exchanger according to claim 4, further comprising a step of providing minute raised portions on surfaces of said grooves when forming said grooves by the roller.

6. A method of manufacturing a multiple-hole tube for heat exchanger according to claim 4 or 5, further comprising flattening said surface on the groove side of the copper plate by rolling with a plain roller after making sectional form of said groove semicircular.
